(19) United States
(12) Patent Application Publication
(10) Pub. No.: US 2023/0134998 A1
(43) Pub. Date: May 4, 2023

(54) NOZZLE NEEDLE FOR A FUEL INJECTOR, AND INJECTOR HOUSING FOR A NOZZLE NEEDLE

(71) Applicant: LIEBHERR-COMPONENTS DEGGENDORF GMBH, Deggendorf (DE)

(72) Inventors: Norbert SCHOEFBAENKER, Ohlsdorf (AT); Richard PIRKL, Regensburg (DE); Klaus WERANECK, Lalling (DE)

(21) Appl. No.: 17/907,637

(22) PCT Filed: Mar. 24, 2021
(86) PCT No.: PCT/EP2021/057510

§ 371 Date: Sep. 28, 2022

(30) Foreign Application Priority Data
Mar. 30, 2020 (DE) 10 2020 108 665.2

(51) Int. Cl. F02M 61/16; F02M 61/12

(52) U.S. Cl. CPC F02M 61/166; F02M 61/12; F02M 61/168; F02M 2200/9015; F02M 2200/9007; F02M 2200/8038; F02M 2200/8046; F02M 51/061

(57) ABSTRACT

A nozzle needle for a fuel injector, the nozzle needle including an elongated nozzle needle main body which has, at one of its two long ends, a nozzle needle tip for selectively closing an injection opening of the fuel injector. The nozzle needle also including a plastic and/or ceramic sleeve for enclosing the nozzle needle main body peripherally along a longitudinal region of the nozzle needle, which longitudinal region is spaced apart from the nozzle needle tip.

### TECHNICAL FIELD

The present invention relates to a nozzle needle for a fuel injector and to an injector housing for a nozzle needle.

### BACKGROUND AND SUMMARY

In internal combustion engines such as diesel engines or gasoline engines, fuel is, as a rule, injected via an injector into a combustion chamber in a specific quantity and for a specific time period. It is necessary in this process due to the very small injection times that are in the microsecond range to open or close the discharge opening of the injector at a very high frequency. It is necessary to provide an injection status detection for an exact control of these closing times and for an exact detection of an injector state so that a higher ranking control unit receives all the information of an individual injector, in particular information with respect to its closing or opening times.

An injector typically has a nozzle needle (also: injector needle) that allows a highly compressed fuel to exit outwardly on release of a discharge hole of the injector. This nozzle needle acts in cooperation with this discharge opening as a plug that enables a discharge of the fuel when raised. It is therefore necessary to raise this needle at relatively short time intervals and to allow it to slide back into the discharge opening after a brief period. In this respect, hydraulic servo valves can be used that control the triggering of this movement. Such valves are in turn controlled with the aid of an electromagnet. Alternatively, a piezo element can be used that responds faster than the valve controlled by means of electromagnets.

Due to the high injection pressures of more than 2500 bar, it is not possible to control or to move the nozzle needle directly with the aid of a magnetic valve. The required force for opening and closing the nozzle needle would be too great here so that such a process would only be able to be implemented with the aid of very large electromagnets. Such a design is, however, precluded due to the limited available installation space in an engine.

So-called servo valves that control the nozzle needle and are themselves controlled via an electromagnetic valve or a piezo valve are typically used instead of direct control. In this respect, a pressure level that acts on the nozzle needle in the closure direction is built up in a control space interacting with the nozzle needle with the aid of the available highly compressed fuel. This control space or this control valve is typically connected to the high pressure region of the fuel via a feed throttle. This control space furthermore has a small closable outflow throttle arranged in the seat plate from which the fuel can escape toward a low pressure region. If the fuel escapes, the pressure in the control space and the closure force acting on the nozzle needle are reduced since the highly compressed fuel of the control space can flow off. A movement of the jet needle is thereby produced that releases the discharge opening at the injector tip. To be able to control the movement of the nozzle needle, the outflow throttle of the valve is therefore selectively closed or opened with the aid of an armature element.

For the further understanding of the general functional principle of a fuel injector, it is shown in the following that the seat plate furthermore has a passage that runs from top to bottom and that represents the outflow throttle of an injector. By placing an armature element and sealing the passage, the control space disposed thereunder fills with highly compressed fuel via an inflow so that the nozzle needle is urged into its closure position. On a raising of the armature element from a passage opening, the fuel stored at high pressure flows off and reduces the force influence acting on the nozzle needle so that it raises from its outlet openings and fuel can hereby flow out.

The more detailed function of an injector is shown, for example, in DE 10 2017 116 383.2.

Since the general principle of an injector for injecting fuel is familiar to the skilled person, the functionality of this component will not be looked at in a more in-depth manner.

As already briefly outlined above, the injector status detection is of great importance for a regulated operation of the injector. With previous injectors, it is not necessary or is very complex and/or expensive to provide a nozzle needle of the injector that is electrically separate from the injector housing and only conducts current or a voltage through to the injector housing when the nozzle needle has closed the at least one discharge opening of the injector. This ability is, however, of advantage with respect to a state recognition since an electric circuit can thus be generated with a closed injector via the contact of the nozzle needle to the nozzle needle seat of the injector housing. The requirement for this is of course that this electric circuit is not already closed at another point (for example in the guide of the nozzle needle) so that the nozzle needle inter alia has to be electrically insulated with respect to the injector housing in a state raised from the at least one discharge opening. The closing of the electric circuit may only take place via the nozzle needle and the nozzle needle seat present at the injector side so that the proposed state detection works.

The nozzle needle of the injector is accordingly a component that is used in accordance with the invention both as a contact element for conducting an electric signal and simultaneously has to be insulated with respect to the injector housing in a state raised from the at least one discharge opening.

It is the aim of the present invention to provide a nozzle needle guide that ensures the desired electrical insulation in a simple manner with a lateral play of the nozzle needle that is as small as possible. Ultimately, a precise nozzle needle guidance is critical for the symmetry of the fuel ejected from an injector, that is produces a uniform spray pattern that is of advantage for the efficiency of a combustion procedure. A precise nozzle needle guidance namely allows the raising of the needle tip from the plurality of discharge openings present at the injector side and as simultaneously as possible the uniform outlet of fuel.

The nozzle needle for a fuel injector accordingly comprises an elongate nozzle needle base body that has a nozzle needle tip for a selective closing of an injection opening of the fuel injector at one of its two longitudinal ends and that is characterized by a plastic and/or ceramic sleeve for surrounding the nozzle needle base body at its peripheral side along a longitudinal region of the nozzle needle that is spaced apart from the nozzle needle tip.

The sleeve thus covers those regions of the nozzle needle base body that can typically come into contact with an injector housing on a raising and lowering of the nozzle needle. To now nevertheless permit a contact with the housing and thus also to simplify the guidance of the nozzle needle, the invention therefore proposes fastening a plastic and/or ceramic sleeve to the nozzle needle base body so that no electrically conductive connection is produced even on a contact of the sleeve with the injector housing. An electrically conductive connection may only take place for a state detection when the nozzle needle tip contacts the nozzle needle seat of the injector housing in the closed state of the injector.

In particular the design of the sleeve by means of ceramic material is of particular advantage here since it has particularly low wear and can be handled easily on its processing.

It is furthermore of advantage that wear is reduced on a sliding and/or rubbing contact between the nozzle needle and the injector housing since ceramics and/or plastic have better properties in this respect.

The lateral excursion of the nozzle needle through the injector housing can be restricted by the provision of the plastic and/or ceramic sleeve without establishing any electrically conductive contact in so doing.

Provision can be made in accordance with a further development of the invention that the plastic and/or ceramic sleeve is fixedly connected to the nozzle needle base body, preferably by a connection with material continuity or shape matching, preferentially by adhesive bonding or soldering.

The nozzle needle base body can furthermore be rotationally symmetrical to its longitudinal axis and the plastic and/or ceramic sleeve can be pivotably symmetrical, but preferably not rotationally symmetrical to the longitudinal axis of the nozzle needle base body.

Due to its pivotably symmetrical design, the sleeve can thus center the elongate nozzle needle base body with respect to a mount that is circular in cross-section and can in so doing still leave space for the flow of fuel under certain circumstances.

Provision can be made in accordance with an optional modification of the present invention that the nozzle needle base body is composed of an electrically conductive material, for example a metal, and the plastic and/or ceramic sleeve is preferably composed of an electrical insulator that comprises, for example, the components Al₂O₃ and/or Si₃Ni₃, or consists of at least one of these two components.

Zirconia is in particular advantageous here since it has a very similar coefficient of thermal expansion to steel and is thereby also well-suited to interference fit assemblies. Due to the thermal expansion behavior being approximately the same, interference fit assemblies can also be implemented for applications having high temperature fluctuations (for example with injection nozzles). Zirconia is very tough in comparison with other ceramic materials and can therefore in particular advantageously be used with abrupt or pulsating strains such as arise due to pressure waves in the injector. Zirconia has considerable advantages tribologically in comparison with aluminum oxide because it causes practically no wear at the contact partners.

Provision can furthermore be made that the plastic and/or ceramic sleeve is arranged in a region between the two longitudinal ends of the nozzle needle base body and the nozzle needle tip and/or the other longitudinal end spaced apart therefrom is/are not surrounded by the plastic and/or ceramic sleeve.

It may be of advantage for a state detection if a voltage (or a current) is applied to the longitudinal end spaced apart from the nozzle needle tip and propagates toward the nozzle needle tip so that a contact with a nozzle needle seat at the housing side results in a detectable closing of an electric circuit. It is, however, of advantage for this purpose that the desired contact points remain free of the insulating sleeve and are designed as electrically conductive.

The invention further relates to an injector housing for a nozzle needle, preferably for a nozzle needle in accordance with one of the preceding variants, with the injector housing furthermore comprising a mount for inserting and guiding the nozzle needle so that it can close an ejection opening of the injector housing in dependence on its insertion position. The housing is characterized in that a plastic and/or ceramic sleeve is present in the mount for the surrounding of the nozzle needle at the peripheral side along a longitudinal region of the nozzle needle that is spaced apart from the ejection opening.

The active principle is comparable with the nozzle needle introduced further above, whereas now the plastic and/or ceramic sleeve is no longer arranged at the nozzle needle, but rather at the injector housing.

A contact is thus likewise possible between a nozzle needle and the injector housing without an electrically conductive connection being established. The lateral play of the nozzle needle can also hereby be correspondingly reduced so that there is a uniform spray pattern on an injection of fuel. In addition, no electrically conductive contact is produced on the guidance of the needle in the housing so that a raising of the needle from its nozzle needle seat at the housing side is detectable.

In this process, provision can be made in accordance with a further development of the invention that the plastic and/or ceramic sleeve is fixedly connected to the injector housing, preferably by a connection with material continuity or shape matching, preferentially by adhesive bonding or soldering.

It also applies to this sleeve that the implementation by a ceramic material is considered particularly advantageous since the wear is also particularly low and the handling capability is very good here.

The plastic and/or ceramic sleeve can furthermore be pivotably symmetrical, preferably rotationally symmetrical, to the longitudinal axis of the injector housing. The sleeve can thus have an annular shape, for example a cylinder jacket shape.

In addition, provision can be made in accordance with an optional modification of the invention that the injector housing is composed of an electrically conductive material, for example a metal, and the plastic and/or ceramic sleeve is preferably composed of an electrical insulator that comprises, for example, the components Al₂O₃ and/or Si₃Ni₃, or consists of at least one of these two components.

Provision can furthermore be made that the plastic and/or ceramic sleeve is arranged in a region between an arrangement position of a control valve and the ejection opening.

The invention further relates to a method of manufacturing a nozzle needle in accordance with one of the variants discussed above, wherein the nozzle needle is only ground after the attachment of the plastic and/or ceramic sleeve to achieve a maximum coaxial alignment of the sleeve and the nozzle needle base body. It is thus ensured that the nozzle needle guide and the nozzle needle tip (in particular the seat cone) are ideally aligned with one another and there are hardly any deviations in the coaxial alignment.

Provision can furthermore be made here that the plastic and/or ceramic sleeve is produced by injection molding or by an additive production process and is preferably fastened to the nozzle needle base body after a debinding and/or a sintering.

The invention additionally relates to a method of manufacturing an injector housing in accordance with one of the variants introduced above, wherein an inner diameter of the plastic and/or ceramic sleeve is only ground after a fixed connection to the injector housing to achieve an optimum coaxial guidance through the sleeve of the nozzle needle to be inserted.

Provision can furthermore be made here that the plastic and/or ceramic sleeve is produced by injection molding or by an additive production process and is preferably fastened to the injector housing after a debinding and/or a sintering.

The invention also relates to a fuel injector having a nozzle needle in accordance with one of the preceding variants and/or to an injector housing in accordance with one of the preceding variants.

It is also accordingly covered by the invention that the nozzle needle has a plastic and/or ceramic sleeve fixedly connected thereto that is received in a guide at the housing side that likewise has a plastic and/or ceramic sleeve fixedly connected to the housing.

### BRIEF DESCRIPTION OF THE FIGURES

Further advantages, features, and details of the present invention will become clear on the basis of the following description of the Figures. There are shown:

FIG. 1: a schematic representation to explain the already known prior art;

FIG. 2: a schematic representation of a nozzle needle in accordance with the invention together with a sectional view in an injection housing; and

FIG. 3: an enlarged representation of an embodiment in accordance with the invention of the present invention.

### DETAILED DESCRIPTION

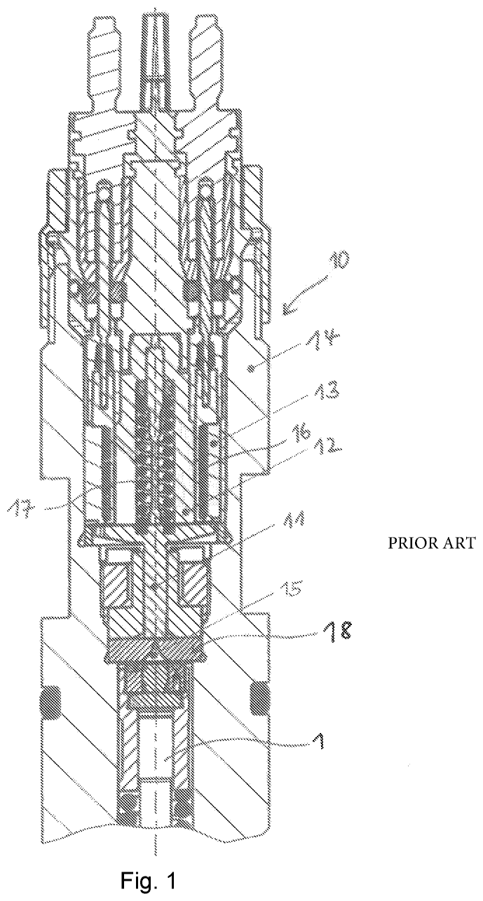

FIG. 1 shows a partial sectional view of an injector 10 from the prior art. The injector 10 can be recognized that has a housing 14 in which a plurality of injector components are arranged. The injector needle 15, the valve formed by the armature 11 and the seat plate 18, and the electromagnet 12, 13 that has a coil winding 16, an inner magnetic pole 12, and an outer magnetic pole 13 are essential to the function of the injector 10 here. A cutout for arranging the spring 17 that urges the armature element 11 in the direction of the valve is furthermore provided in the inner magnetic pole 12 to close the outflow throttle of the valve in a currentless state of the electric magnet 12, 13 in a fluid tight manner.

If the electromagnet 12, 13 is activated, it pulls the armature element 11 away from the valve with the aid of magnetic force so that highly compressed fuel can flow out of the passage 19 from a control space closable by the valve. Since the pressure in the control space that acts on the injector needle is hereby reduced, the latter can slide out of a closed position and enables the discharge of fuel from the injector 10. If, in contrast, the electromagnet 12, 13, is moved into a currentless state, the magnetic force acting on the armature element 11 is reduced so that the spring element 17 urges the armature element 11 onto the discharge opening of the valve and seals the control space or the passage 6. The pressure acting on the injector needle 15 thereby increases so that the latter is again urged into its closed position. There is accordingly no longer any outflow of fuel from the discharge opening of the injector 10.

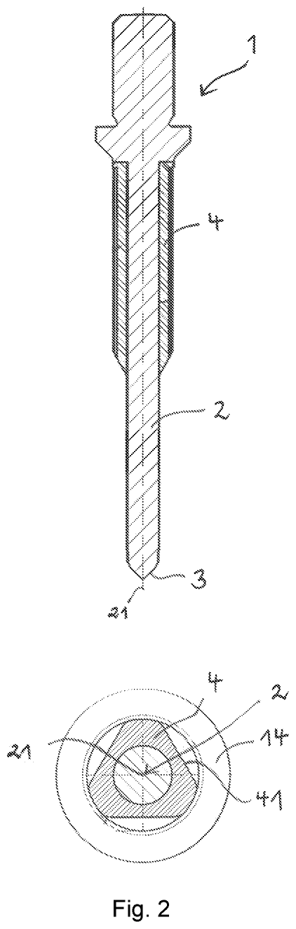

In its upper region, FIG. 2 shows a longitudinal sectional view of a nozzle needle 1 in accordance with the present invention. It can be recognized that the nozzle needle base body 2 has a substantially rod-like basic design and converges to a point at one of its longitudinal ends. The nozzle needle tip 3 that converges to a point serves in an injector 10 to close the at least one fuel discharge opening.

It can be recognized in a region disposed between the two longitudinal ends that the nozzle needle base body 2 is surrounded by a plastic and/or ceramic sleeve 4 that effects an electrical insulation with respect to an injector housing 14.

Unlike the nozzle needle base body 2, this sleeve 4 can also be designed not as rotationally symmetrical, but, for example, only pivotably symmetrical to the longitudinal axis 21 of the nozzle needle base body 2.

The lower section of FIG. 2 is a cross-sectional view of the nozzle needle at the level of the sleeve 4 from the upper section of FIG. 2 in a state inserted into an injector housing 14.

The injector housing 14 here has a circular inner periphery in which the nozzle needle 1 is received. The nozzle needle 1 is movable in its longitudinal direction, that is in parallel with the longitudinal axis 21, so that it can be moved into an open position from a closure position of the injector 10 in which the discharge opening is closed by the nozzle needle tip 3. For this purpose, it is raised upwardly in the longitudinal direction and an outflow of fuel takes place.

The sleeve 4 can have a substantially pivotably symmetrical form that does not adjoin the inner periphery of the housing in a continuously flush manner in the peripheral direction. An approximately triangular base shape can thus be selected as in the present case, with each of the corners having a flush area toward the circular segment of the inner periphery of the injector. A space that can be used for the flow of fuel toward a discharge opening can be provided between the outer surfaces 41 of the sleeve 4 and the inner periphery of the injector 14.

It is clear to the skilled person that the present invention is not restricted to the specific design of the sleeve 4 shown in FIG. 2, but rather comprises a plurality of possible forms.

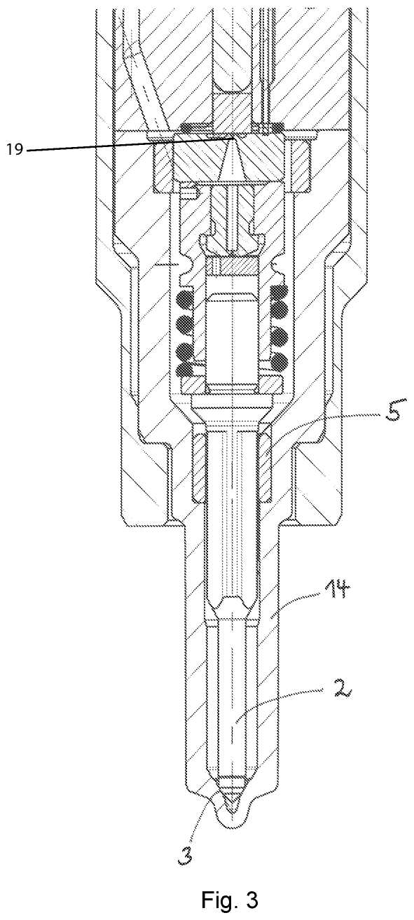

FIG. 3 shows a longitudinal sectional view of a lower part of a fuel injector that is equipped with a nozzle needle 1 and an injector housing 14 in accordance with the invention.

It can be recognized that the injector housing 14 has a plastic and/or ceramic sleeve 5 in a guide region for guiding the nozzle needle 1 so that an electrically conductive contact of the injector housing 14 with the nozzle needle only takes place in the nozzle needle tip with a closed injector.

The plastic and/or ceramic sleeve 5 arranged at the housing 14 can be fixedly connected there, for example by soldering or adhesive bonding.

The plastic and/or ceramic sleeve 5 arranged at the housing 14 can thus have a cylinder jacket shape and ensure a flow of fuel through a corresponding adapted shape of the nozzle needle.

Provision can additionally made for the further reduction of wear that the nozzle needle 1 is also provided with a plastic and/or ceramic sleeve arranged at it so that on a movement of the nozzle needle, there is only a contact of plastic and/or ceramic material. This represents a particularly low-friction contact that results in particularly low wear due to comparable surface hardnesses.

1. A nozzle needle for a fuel injector comprising:
an elongate nozzle needle base body, wherein the elongate nozzle needle base body has a nozzle needle tip at one longitudinal end for a selective closing of an ejection opening of the fuel injector, and
a plastic and/or ceramic sleeve surrounding the elongate nozzle needle base body at the peripheral side along a longitudinal region of the nozzle needle and spaced apart from the nozzle needle tip.

2. The nozzle needle in accordance with claim 1, wherein the plastic and/or ceramic sleeve is fixedly connected to the elongate nozzle needle base body.

3. The nozzle needle in accordance with claim 1, wherein the elongate nozzle needle base body is rotationally symmetrical to its longitudinal axis and the plastic and/or ceramic sleeve is pivotably symmetrical.

4. The nozzle needle in accordance with claim 1, wherein the elongate nozzle needle base body is composed of an electrically conductive material.

5. The nozzle needle in accordance with claim 1, wherein the plastic and/or ceramic sleeve is arranged in a region between two longitudinal ends of the elongate nozzle needle base body and the nozzle needle tip and/or the other longitudinal end spaced apart therefrom is not surrounded by the plastic and/or ceramic sleeve.

6. An injector housing for a nozzle needle, comprising:
a mount for inserting and guiding the nozzle needle so that the nozzle needle can close an ejection opening of the injector housing in dependence on the nozzle needle insertion position,
a plastic and/or ceramic sleeve for surrounding a nozzle needle base body at the peripheral side along a longitudinal region of the nozzle needle and spaced apart from the ejection opening.

7. The nozzle needle in accordance with claim 6, wherein the plastic and/or ceramic sleeve is fixedly connected to the injector housing.

8. The nozzle needle in accordance with claim 6, wherein the plastic and/or ceramic sleeve is pivotably symmetrical to a longitudinal axis of the injector housing.

9. The injector housing in accordance with claim 6, wherein the injector housing (H) is composed of an electrically conductive material.

10. The injector housing in accordance with claim 6, wherein the plastic and/or ceramic sleeve is arranged in a region between an arrangement position of a control valve and the ejection opening.

11. A method of manufacturing a nozzle needle comprising an elongate nozzle needle base body wherein the elongate nozzle needle base body has a nozzle needle tip at one longitudinal end for a selective closing of an ejection opening of a fuel injector, a plastic and/or ceramic sleeve surrounding the elongate nozzle needle base body, at the peripheral side along a longitudinal region of the nozzle needle and spaced apart from the nozzle needle tip, wherein the nozzle needle is only ground after attachment of the plastic and/or ceramic sleeve to achieve a maximum coaxial alignment of the sleeve and the elongate nozzle needle base body.

12. The method of manufacturing the nozzle needle in accordance with claim 11, wherein the plastic and/or ceramic sleeve is produced by injection molding or by an additive production process.

13. The method of manufacturing the nozzle needle in accordance with claim 11, wherein an inner diameter of the plastic and/or ceramic sleeve is only ground after a fixed connection to an injector housing to achieve an optimum coaxial guidance through the sleeve of the nozzle needle to be inserted.

14. The method in accordance with claim 13 wherein the plastic and/or ceramic sleeve is produced by injection molding or by an additive production process.

15. A fuel injector having a nozzle needle
wherein the nozzle needle comprises an elongate nozzle needle base body;
wherein the elongate nozzle needle base body has a nozzle needle tip at one longitudinal end for a selective closing of an election opening of the fuel injector and a plastic and/or ceramic sleeve surrounds the elongate nozzle needle base body, at the peripheral side along a longitudinal region of the nozzle needle and spaced apart from the nozzle needle tip.

16. The nozzle needle in accordance with claim 2, wherein the plastic and/or ceramic sleeve is connected to the elongate nozzle needle base body by a connection with material continuity or shape matching.

17. The nozzle needle in accordance with claim 3, wherein the plastic and/or ceramic sleeve is not rotationally symmetrical to the longitudinal axis of the elongate nozzle needle base body.

18. The nozzle needle in accordance with claim 4, wherein the plastic and/or ceramic sleeve of the nozzle needle is composed of an electrical insulator comprising at least one of Al₂O₃ or Si₃Ni₃.

19. The method in accordance with claim 12, wherein the plastic and/or ceramic sleeve is fastened to the elongate nozzle needle base body after a debinding and/or a sintering.

20. A fuel injector having a nozzle needle with an injector housing, wherein the injector housing comprises:
a mount for inserting and guiding the nozzle needle so that the nozzle needle can close an ejection opening of the injector housing in dependence on the nozzle needle insertion position, and
a plastic and/or ceramic sleeve within the mount, wherein the plastic and/or ceramic sleeve surrounds a nozzle needle base body at the peripheral side along a longitudinal region of the nozzle needle is spaced apart from the ejection opening.
